(19) United States
(12) Patent Application Publication
(10) Pub. No.: US 2005/0049391 A1
(43) Pub. Date: Mar. 3, 2005

(54) Polyester composition and articles with reduced acetaldehyde content and method using vinyl esterification catalyst

(76) Inventors: Mark Rule, Atlanta, GA (US); Yu Shi, Alpharetta, GA (US)

Correspondence Address: SUTHERLAND ASBILL & BRENNAN LLP, 999 PEACHTREE STREET, N.E., ATLANTA, GA, 30309, US

(21) Appl. No.: 10/650,150

(22) Filed: Aug. 28, 2003

(51) Int. Cl. C08G 18/70; C08G 2/00

(52) U.S. Cl. 528/480; 528/67

(57) ABSTRACT

A polyester composition with reduced acetaldehyde concentration comprising polyester and at least one vinyl esterification catalyst. A method for making the polyester composition is also disclosed along with polyester articles made with the polyester composition. Suitable articles include containers such as bottles.

### FIELD OF INVENTION

The present invention relates to a method of decreasing the acetaldehyde content of polyesters by incorporation into the polyester an effective amount of a vinyl ester transesterification catalyst, followed by volatilization of acetaldehyde and methyl dioxolane from the polymer.

### BACKGROUND OF INVENTION

Polyesters, especially poly(ethylene terephthalate) (PET) are versatile polymers that enjoy wide applicability as fibers, films, and three-dimensional structures. A particularly important application for PET is for containers, especially for food and beverages. This application has seen enormous growth over the last 20 years, and continues to enjoy increasing popularity. Despite this growth, PET has some fundamental limitations that restrict its applicability. One such limitation is its tendency to generate acetaldehyde (AA) when it is melt processed. Because AA is a small molecule, AA generated during melt processing can migrate through the PET. When PET is processed into a container, AA will migrate over time to the interior of the container. Although AA is a naturally occurring flavorant in a number of beverages and food products, for many products the taste imparted by AA is considered undesirable. For instance, AA will impart a fruity flavor to water, which detracts from the clean taste desired for this product.

PET is traditionally produced by the transesterification or esterification/polymerization of a terephthalate precursor (either dimethyl terephthalate or terephthalic acid) and ethylene glycol. If the end use application for the melt-polymerized PET is for food packaging, the PET is then subject to a second operation known as solid-state polymerization (SSP), where the molecular weight is increased and the AA generated during melt polymerization is removed. A widely used method to convert the SSP PET into containers consists of drying and remelting the PET, injection molding the polymer into a container precursor (preforms), and subsequently stretch blow-molding the preform into the final container shape. It is during the remelting of the PET to fashion the container preforms that AA is regenerated. Typical preform AA levels for PET processed in the most modern injection molding equipment is 6-8 ug/g (ppm).

Historically, the impact of AA on product taste has been minimized by careful control of the melt processing conditions used to make containers or preforms, and by use of special processing conditions in polymer preparation. This approach is successful for most products where the taste threshold for AA is sufficiently high, or where the useful life of the container is sufficiently short. However, obtaining low AA carries with it a significant cost. That cost includes the need to carry out a separate processing step after the melt polymerization of PET (solid-state polymerization), the need for specially designed injection molding equipment, and the need to continually monitor the AA content during container production. For other applications, where the desired shelf-life of the container is longer, the product is more sensitive to off-taste from AA, or the prevailing environmental conditions are warmer, it is not possible to keep the AA level below the taste threshold by using these methods. For example, in water, the taste threshold is considered to be less than about 40 ug/L (ppb), and often a shelf-life of up to two years is desired. For a PET bottle that contains 600 ml of beverage, a preform AA content of 8 ppm can result in a beverage AA level greater than 40 ppb in as little as one month. For these reasons, there has been considerable efforts directed toward developing technologies to minimize the AA generated during melt processing of PET and other polyesters.

In addition to careful control of melt-processing conditions for PET, prior art methods include use of lower IV resins and the use of lower melting PET resins. Each of these approaches has been only partially successful, and each suffer from their own limitations. For example, lower IV resins produce containers that are less resistant to environmental factors such as stress crack failure. Lower melting resins are achieved by increasing the copolymer content the PET resin; however, increasing the copolymer content also increases the stretch ratio of the PET, which translates into decreased productivity in injection molding and blow molding.

Another prior art approach has been to incorporate additives into PET that will selectively react with, or scavenge, the AA that is generated. Thus, Igarashi (U.S. Pat. No. 4,837,115) claims the use of amine-group terminated polyamides and amine-group containing small molecules. Igarashi teaches that the amine groups are effective because they can react with AA to form imines, wherein the amine nitrogen forms a double bond with the AA moiety. Igarashi teaches that essentially any amine is effective. Mills (U.S. Pat. Nos. 5,258,233; 5,650,469; and 5,340,884) and Long (U.S. Pat. No. 5,266,416) claim the use of various polyamides, especially low molecular weight polyamides. Turner and Nicely (WO 97/28218) claim the use of polyesteramides. These polyamides and polyesteramides are believed to react with AA in the same manner as described by Igarashi. Imine formation is almost always accompanied by the formation of a yellow color, which is undesirable in many polyester products. U.S. Pat. No. 6,274,212 describes a class of AA scavengers that sequester AA by forming cyclic 5 or 6-member ring compounds, and have a much reduced tendency to form color.

While AA scavengers are effective at reducing the AA content of melt-processed PET, they all rely on the stoichiometric reaction of acetaldehyde with a sequestering reagent. In addition, in all of these prior art AA scavengers, the sequestering reaction is an equilibrium reaction. Consequently, in all cases a significant excess of the AA scavenger must be employed. Moreover, once the capacity of the reagent is exhausted, any additional AA formed cannot be sequestered.

All of the above approaches are directed toward minimizing the amount of AA regenerated on melt-processing of polyester resins that have an initially low content of AA, and where the amount of AA generated in the absence of the invention would be limited to about 5-10 ppm AA. Consequently, while these methods can be effective at decreasing the AA generated during melt-processing of an SSP resin, they will be either ineffective or uneconomical in reducing the AA content of a melt-phase (non-solid state polymerized) resin, since the equilibrium AA content of PET during melt polymerization is typically 25-100 ppm.

A prior art approach to controlling acetaldehyde in melt-processed polyesters is based on the concept of removing contained acetaldehyde by purging or stripping the acetaldehyde from the polyester melt immediately prior to its formation into a solid article. This approach thus offers the potential, at least in principle, to remove any amount of contained acetaldehyde, and thus might allow the direct use of melt-phase (non-solid state polymerized) PET for AA-sensitive applications.

Thus, U.S. Pat. No. 5,656,221 claims a process for producing solid articles from a polyester melt that consists of purging a polyester melt directly after the polymerization reactor with an inert gas, followed by vacuum stripping prior to solidification of the melt, optionally with the addition of an AA scavenger. U.S. Pat. No. 5,656,719; WO 9702126A, U.S. Pat. No. 5,597,891; U.S. Pat. No. 5,648,032; and WO 9731968A also describe similar processes with various modifications. However, in spite of the elaborate devices envisioned in the above patents, the amount of AA removed by these technologies is relatively small. AA reductions on the order of only 20-30% are achieved in most instances, and with the residual AA content being substantially greater than 20 ppm, well above the acceptable level for all but the most forgiving of applications.

Thus, it would therefore be an advance in the state of the art to develop a process for decreasing the AA content of melt-processed polyesters that does not suffer from these prior art limitations, and that could effectively remove essentially all of the AA contained in those polyesters, such that polyester articles made from such polymers could be used even in the most AA-sensitive applications.

### SUMMARY OF INVENTION

It is therefore desirable to provide a method to decrease the acetaldehyde content of melt-processed polyesters, especially polyesters that have a high level of contained acetaldehyde. It is preferable to decrease the acetaldehyde content of melt processed polyesters in an economical fashion that does not rely on expensive additives or elaborate processing equipment. It is also preferable to provide a method for decreasing the acetaldehyde content of polyesters which does not create significant off-color. In addition, it is preferable to provide a method to decrease the acetaldehyde content of melt-polymerized polyester resin to acceptable levels and at a reasonable cost.

The present invention is based on the discoveries that 1) in polyester melts, most of the contained acetaldehyde is actually present as vinyl ester end groups, and to a lesser extent as methyl dioxolane, and that the actual amount of free acetaldehyde present in the polyester melt at any time is less than about 10% of the total; 2) certain catalysts can be added to polyester melts that will rapidly convert the contained vinyl ester end groups into free acetaldehyde and methyl dioxolane; and 3) contrary to the prior art teachings, acetaldehyde and methyl dioxolane can be removed from polyester melts extremely easily, using the simplest of venting operations.

Thus, the present invention encompasses a method for substantially decreasing the acetaldehyde content of melt-processed polyesters which contain ethylene linkages, especially PET, by the incorporation of effective levels of one or more vinyl ester transesterification catalysts into the polyester for catalyzing conversion of vinyl ester end groups in the polyester to acetaldehyde, and in some embodiments, methyl dioxolane, heating the polyester, and providing an egress whereby the formed acetaldehyde and methyl dioxolane can be removed from the polymer. The transesterification catalysts can be selected from polyester catalysts. The egress can be any venting operation disclosed in the prior art, including a simple opening in an extruder barrel. Because acetaldehyde is generated continuously in molten polyesters, it is desirable to locate the egress as close to the point of polymer solidification as feasible. Further reduction of acetaldehyde can be accomplished by the incorporation of AA scavengers, if needed.

More particularly, the present invention encompasses a method of decreasing acetaldehyde in melt-polymerized polyesters by incorporating a vinyl ester transesterification catalyst into the polyester and providing an egress for acetaldehyde and methyl dioxolane from the polyester just prior to solidification of the polyester. The present invention also encompasses a polyester composition comprising polyester and an active transesterification catalyst. The polyester may be based on polyethylene terephthalate or polyethylene naphthalate or the like. Suitable transesterification catalysts include lithium, sodium, potassium, magnesium, calcium, strontium, barium, lanthanum, samarium, and titanium.

Other objects features and advantages of preferred embodiments of this invention will become apparent to those skilled in the art upon understanding the following detailed description and accompanying drawings.

### DETAILED DESCRIPTION

As summarized above, the methods of the present invention provide a process of reducing or eliminating acetaldehyde in polyester. By reducing the amount of acetaldehyde in the polyester, the potential for off-taste from the polyester is decreased.

Generally, the present invention encompasses a method of decreasing acetaldehyde in polyester by incorporating a vinyl ester transesterification catalyst into the catalyst, heating the polyester, and providing an egress for acetaldehyde and methyl dioxolane from the polyester. The present invention also encompasses a polyester composition comprising polyester and an active vinyl ester transesterification catalyst. In addition, the present invention encompasses articles, such as containers, made with the foregoing polyester composition, the method of making such articles, a bottled beverage comprising a polyester-based container and a beverage in the container, and a method for making the packaged beverage.

Examples of transesterification catalysts effective for the present invention include the Group Ia and IIa metal ions, including lithium, sodium, potassium, magnesium, calcium, strontium, barium, and the like. These metal ions are preferred because they are effective at inducing the conversion of vinyl ester end groups into acetaldehyde. Thus, the term vinyl ester transesterification catalyst as used herein means a transesterification catalyst that induces conversion of vinyl ester end groups into acetaldehyde without also inducing formation of vinyl esters. Especially preferred ions are potassium and calcium. While not as effective as calcium, mild transesterification catalysts may also be used. The lanthanide metals are within this category and include lanthanum and samarium. Additionally titanium has been found to be an effective transesterification catalyst. Other metal ions that are not preferred include zinc, gallium, antimony, aluminum, and other known transesterification and polymerization catalysts. These catalysts are not preferred because they are either ineffective for the conversion of vinyl esters into acetaldehyde, they are active for promoting the formation of vinyl esters by cleavage of ethylene linkages, or both. Surprisingly, the metal ions most preferred for conversion of vinyl esters to acetaldehyde are regarded as the least effective transesterification catalysts for polyester production, and their use therefore has been extremely limited or non-existent. Moreover, in polyester production phosphate ion is added prior to the polymerization reaction, in order to neutralize any transesterification catalysts (other than germanium, titanium, or antimony). Consequently, in all prior art polymer syntheses, the very catalysts that would be most effective for promoting the conversion of vinyl esters to acetaldehyde without the concomitant generation of vinyl esters have been either absent or neutralized.

The amount of vinyl ester transesterification catalyst added to the polyester varies but preferably is present in the polyester in an amount from about 5 to about 1000 ppm. More preferably, the vinyl ester transesterification catalyst is present in the polyester in an amount from about 25 to about 250 ppm.

In a preferred embodiment of the present invention, the method of reducing acetaldehyde further comprises forming the polyester into a solid article after the vinyl ester transesterification catalyst is incorporated into a polyester melt, and egress is provided for the release of acetaldehyde and methyl dioxolane. In another embodiment, the vinyl ester transesterification catalyst is incorporated into the polyester melt, the polyester melt is formed into a first solid article, and is subsequently remelted. After remelting, an egress is provided for the release of the contained acetaldehyde and methyl dioxolane, and the polyester is then formed into a second solid article. In a third embodiment, the vinyl ester transesterification catalyst is incorporated into the polyester melt, and the polyester is then formed into a solid article. Subsequently, the polyester is heated to a temperature below its melting point, but sufficient to cause the contained acetaldehyde and methyl dioxolane to migrate from the polyester article via diffusion through the polymer bulk.

The method of incorporation of the active vinyl ester transesterification catalyst into polyesters is not critical. The catalyst can be incorporated into the polyester at any time prior to, during, or after melt polymerization. In other words, the catalyst may be added to the polyester during original formation of the polyester or during subsequent melt-processing of the polyester. It can be incorporated by spraying a slurry of the catalyst onto the polyester pellets prior to or after solid state polymerization or drying. It can be incorporated by injection of a melt, solution, or suspension of the catalyst into pre-melted polyester. It may also be incorporated by making a masterbatch of the catalyst with polyester and then mixing the masterbatch pellets with polyester pellets at the desired level before drying and injection molding or extrusion.

The egress for the formed acetaldehyde can be provided at any time after the addition of the transesterification catalyst. Preferably, the egress is provided immediately prior to quenching the molten polyester.

The polyesters that the present invention are effective for can be broadly described as polyesters that contain an ethylene linkage. Polyesters that include such a linkage include poly(ethylene terephthalate), poly(ethylene naphthalate), poly(ethylene adipate), poly(ethylene isophthalate), and blends or copolymers of the same. Additional glycol linkages that may be present as comonomers include cyclohexanedimethanol, diethylene glycol, 1,2-propanediol, neopentylene glycol, 1,3-propanediol, and 1,4-butanediol.

The most preferred polyesters are PET and derivatives thereof. PET is a high molecular weight condensation polymer. PET is currently produced in large volumes for three major markets: fiber, bottle resin, and film. Although PET is effectively the same polymer for all three markets, some of its properties can be modified by additives and changes in molecular weight, and all producers of PET tailor their product, to the extent practical, to optimize downstream processing and final performance properties for the specific application.

The polymerization catalyst used for the present invention is not critical, so long as it is not exceptionally active for the formation of vinyl ester end groups. Suitable polymerization catalysts include antimony, titanium, germanium, and tin compounds. The use of phosphate as a polymerization moderator is also acceptable, with the caveat that excessive amounts of phosphate will neutralize the added vinyl ester transesterification catalyst; therefore, sufficient catalyst must be added to overcome the neutralizing effect of any phosphate present.

The method of eliminating acetaldehyde as disclosed in the present invention is applicable to any type of polyester-based container used to transport or store beverages. Suitable containers include, but are not limited to, bottles, drums, carafes, coolers, etc. Thus, according to one embodiment of the present invention, a bottled beverage is provided in a polyester-based container, wherein the polyester-based container comprises an active vinyl ester transesterification catalyst. Still another embodiment of this invention is a container preform made from the polyester composition of this invention. A beverage container can then be made with the preform by conventional means. The vinyl ester transesterification catalyst can be added to the polyester during original formation of the PET or during subsequent manufacture of preforms from PET pellets. The preforms can be made by melt-processing PET pellets or by immediately melt-processing the PET during original formation or synthesis of the PET without the intermediate step of forming PET pellets or otherwise solidifying the PET prior to forming the preform. In this embodiment, it is anticipated that the polyester can be produced by melt-phase polymerization to the desired molecular weight, an egress for the contained acetaldehyde and methyl dioxolane is provided, and the polyester melt is then directly transformed into the shaped article. In this embodiment, addition of the active vinyl ester transesterification catalyst will occur prior to formation of the shaped article, with the egress for the contained acetaldehyde being provided after the addition of the vinyl ester transesterification catalyst and prior to the formation of the solid article.

The present invention is useful in reducing the level of acetaldehyde in polyester containers and thus reducing the amount of acetaldehyde that can migrate into any type of beverage, in order to prevent off-taste of the beverage from occurring. Depending upon the type of beverage being used, the taste threshold of acetaldehyde may vary. However, it is preferred that the concentration of acetaldehyde in the beverage be decreased to approximately less than 40 ppb. More preferably, the concentration of acetaldehyde in the beverage is decreased to less than 20 ppb.

As indicated above, the present invention may be used to improve the taste of any type of beverage including, but not limited to water, colas, sodas, alcoholic beverages, juices, etc. However, it is particularly useful for preventing the off-taste of sensitive products such as water.

The present invention is described above and further illustrated below by way of examples, which are not to be construed in any way as imposing limitations upon the scope of the invention. On the contrary, it is to be clearly understood that resort may be had to various other embodiments, modifications, and equivalents thereof which, after reading the description herein, may suggest themselves to those skilled in the art without departing from the spirit of the present invention and/or scope of the appended claims.

### EXAMPLES

The following examples illustrate the use of the present invention for decreasing the acetaldehyde content of melt-processed PET, with the exception of examples 1-6, 8, 9, 11, 12, 16, 19, 20, 21, and 26 which are comparative examples. All unit cavity experiments were performed using an Arburg vented barrel, where the vent port was a simple 1 inch by 2 inch opening in the barrel body ½ of the distance between the pellet infeed and the opening to the preform cavity. All resin processing was carried out with a constant 280 deg C. temperature profile across the barrel length. Because of this configuration, 50% of the acetaldehyde generated during injection molding occurs prior to the vent port, with another 50% being generated after the vent port. Consequently, the maximum amount of AA reduction possible with this configuration using a SSP resin (initial AA level near 0 ppm) with the vent port open is 50% of that with the vent port closed, and a thus 50% AA preform AA reduction corresponds to complete removal of all AA at the vent port. In these experiments, when the vent port was open, the surface of the polymer melt was swept with a stream of dry nitrogen at a flowrate of 500 cc/min.

In these examples, the acetaldehyde content was determined by taking a representative portion of the melt-processed polyester, grinding to pass a 2 mm screen, and desorbing the contained acetaldehyde from the polyester by heating at 150 deg C. for 45 minutes in a sealed vial. The desorbed acetaldehyde was then analyzed using a gas chromatograph equipped with a flame ionization detector. Beverage acetaldehyde levels were determined by removing a 5 ml aliquot of the beverage, placing the aliquot into a 20 ml vial, adding 1 gram of sodium chloride, and desorbing the contained acetaldehyde at 85 deg C. for 10 minutes, followed by analysis of the beverage headspace using a gas chromatograph equipped with a flame ionization detector. Headspace acetaldehyde was determined by capping a freshly blow-molded container, storing for 24 hours at 22 deg C., and measuring the acetaldehyde content of the contained air by gas chromatography.

### Examples 1-4

In the following examples, SSP PET resin prepared with germanium, titanium, and antimony catalysts were injection molded into 24 gram preforms. The processing temperature was maintained at a constant 280 deg C. across the barrel. The cycle time was 30 seconds, which corresponds to a residence time of about 110 seconds. All resins were dried to less than 50 ppm residual moisture prior to molding. The results below are reported as % decrease in AA content for the vented configuration vs. the same resin processed in the unvented configuration. The equation for calculating the percent decrease in acetaldehyde (AA) content is as follows:

Percent decrease = (AA content control − AA content
test material)/(AA control)) × 100

| | | Initial Resin | | | |
|---|---|---|---|---|---|
| Example | Resin | Content AA | Ppm AA | Ppm AA | % AA |
| No. | Catalyst | (ppm) | unvented | vented | Decrease |
| 1 | Sb | <0.5 | 9.88 | 8.71 | 11.8 |
| 2 | Ti | <0.5 | 9.98 | 8.08 | 19.0 |
| 3 | Ge | <0.5 | 8.25 | 6.71 | 18.6 |
| 4 | Ti | 25.2 | 34.3 | 28.9 | 15.7 |

These examples show that a simple venting operation is relatively ineffective at reducing the preform AA vs. an unvented control, even when the initial resin AA content was very high (example 4 is a high IV resin that has not been subjected to solid-state polymerization).

### Examples 5-8

In the following examples, a PET resin containing 18 ppm Ti as the polymerization catalyst was dried in a vacuum oven to below 50 ppm residual moisture. The selected vinyl transesterification catalysts were suspended in mineral oil, coated onto the PET pellets by tumbling, and then the PET pellets were fed into the Arburg as before. The processing temperature was maintained at a constant 280 deg C. across the barrel. The cycle time was 30 seconds, which corresponds to a residence time of about 110 seconds. The results below are reported as % decrease in AA content for the vented configuration vs. the same resin variable processed in the unvented configuration. The equation for calculating the percent decrease in acetaldehyde (AA) content is as before.

| | | Initial | | | |
|---|---|---|---|---|---|
| | | Resin | | Ppm | |
| Example | Added | AA Content | Ppm AA | AA | % AA |
| No. | Catalyst | (ppm) | unvented | vented | Decrease |
| 2 | — | <0.5 | 9.88 | 8.71 | 11.8 |
| (from | | | | | |
| above) | | | | | |
| 5 | 25 ppm Ti | <0.5 | 17.13 | 8.93 | 47.9 |
| 6 | 50 ppm Ti | <0.5 | 17.39 | 8.84 | 49.2 |
| 7 | 50 ppm K | <0.5 | 9.36 | 4.86 | 48.1 |
| 8 | 50 ppm Zn | <0.5 | 81.03 | 42.12 | 48.0 |

These examples demonstrate that Ti, Zn, and K are all active as vinyl ester transesterification catalysts, but that Ti and Zn are also active for the creation of vinyl ester groups. Consequently, of the above examples, only K (potassium ion, added as potassium acetate) offered a net benefit in preform AA over the vented example 2.

### Examples 9-11

Preforms from Example 7 (both vented and unvented) and Example 2 (unvented) were blown into bottles, and both the headspace AA (after 24 hours) and the beverage AA (after the indicated number of days at 22 deg C.) were measured.

| | | Initial | | | |
|---|---|---|---|---|---|
| | Bottles made | Preform | | | |
| | from preforms | AA | | | No. |
| Example | from | Content | Headspace | Beverage | days |
| No. | Example: | (ppm) | AA mg/L | AA ppb | in test |
| 9 | 7 unvented | 9.36 | 4.82 | 27.9 | 10 |
| 10 | 7 vented | 4.86 | 2.12 | 5.8 | 13 |
| 11 | 2 unvented | 9.88 | 3.84 | 21.6 | 10 |

These examples demonstrate that the improvement in preform AA observed with the addition of potassium coupled with venting translates into a significant improvement in both headspace and beverage AA.

### Examples 12-21

In the following examples, an antimony-based PET resin that contained an additional 40 ppm phosphate as a catalyst moderator was used as the base resin. For each variable, 1 umol/gram of the indicated catalyst was added and the resin was molded as before.

| | | Initial Resin | | Ppm | |
|---|---|---|---|---|---|
| Example | Added | AA Content | Ppm AA | AA | % AA |
| No. | Catalyst | (ppm) | unvented | vented | Decrease |
| 12 | — | <0.5 | 13.07 | 9.55 | 26.9 |
| 13 | Li acetate | <0.5 | 20.45 | 10.17 | 50.3 |
| 14 | Na acetate | <0.5 | 10.86 | 9.27 | 14.6 |
| 15 | K acetate | <0.5 | 13.00 | 9.32 | 28.3 |
| 16 | Ti | <0.5 | 10.48 | 9.00 | 14.1 |
| | isopropoxide | | | | |
| 17 | Mg acetate | <0.5 | 18.02 | 14.17 | 21.3 |
| 18 | Ca acetate | <0.5 | 11.44 | 6.31 | 44.8 |
| 19 | Ga acac | <0.5 | 89.42 | 87.46 | 2.2 |
| 20 | Zn acetate | <0.5 | 49.13 | 17.98 | 63.4 |
| 21 | Mn acetate | <0.5 | 18.58 | 9.89 | 46.7 |

### Example 22-25

In the following examples, a Ti-catalyzed PET resin was used with 20 ppm of Ti as the polymerization catalyst. The resin was dried in a vacuum oven to below 50 ppm residual moisture. The resin was injection molded as in Examples 1 to 9. It is seen from the examples that the mild transesterification catalysts such as lanthanum and samarium, when coupled with venting, resulted in the total less preform AA than that of control.

| Example | | Initial resin AA | Ppm AA | Ppm AA |
|---|---|---|---|---|
| No | Added catalyst | (ppm) | unvented | vented |
| 22 | None | <0.5 | 13.34 | 10.49 |
| 23 | 176 ppm Ca Acetate | <0.5 | 8.45 | 7.88 |
| 24 | 100 ppm Lanthanum | <0.5 | 11.02 | 9.42 |
| 25 | 100 ppm Samarium | <0.5 | 11.27 | 10.37 |

### Example 26-31

In the following examples, a Ti-catalyst resin was used. The resin was melt plolymerized to an IV of 0.80, with solid stating polymerization. Therefore, the resin is in amorphous phase. The resin was dried at 70 deg C. in a vacuum oven for three days to a moisture level below 50 ppm. The resin was then blended with different additives and fed into a Bradender single screw extruder at 270 deg C. and 50 rpm with a nitrogen purge in the hopper. The extrudates were quenched in and pellitized. The undried pellets were remelted at 280 deg C., under a continuous nitrogen purge at 9.5 cubic feet/min for 2 and 4 minutes to simulate the direct melt to preform process (melt polymerization to IV of 0.80 or higher without SSP, followed by molding to articles), and quenched immediately. The quenched remelts were then grounded and test for AA content as described in the previous examples.

| | | | ppm AA | ppm AA |
|---|---|---|---|---|
| Example | | ppm AA | vented | vented |
| No | Added catalyst | unvented | 2 min. | 4 min |
| 26 | None | 36.0 | 21.8 | 21.1 |
| 27 | 100 ppm Lanthanum | 37.0 | 15.3 | 15.3 |
| | Acetate hydrate | | | |
| 28 | 100 ppm Samarium | 31.4 | 18.9 | 16.9 |
| | acetate hydrate | | | |
| 29 | 176 ppm Calcium acetate | 22.9 | 13.1 | 13.3 |
| | monohydrate | | | |
| 30 | 214 ppm Magnesium | 24.1 | 16.3 | 16.6 |
| | acetate tetrahydrate | | | |
| 31 | 284 ppm Titanium | 20.4 | 15.1 | 15.2 |
| | isopropoxide | | | |

These examples demonstrated that all the added catalyst dramatically decreased the AA when the reaction time is more than 2 minutes. This is especially true with Lanthanum and Samarium.

It should be understood that the foregoing relates to particular embodiment of the present invention, and that numerous changes may be made therein without departing from the scope of the invention as defined by the following claims.

1. A method of reducing the amount of acetaldehyde in a melt-processed polyester having vinyl ester end groups, the method comprising incorporating into the polyester at least one active vinyl ester transesterification catalyst for catalyzing conversion of the vinyl ester end groups to acetaldehyde, heating the polyester, and providing egress for the acetaldehyde from the polyester.

2. A method as in claim 1, wherein the melt-processed polyester is based on polyethylene terephthalate.

3. A method as in claim 1, wherein the transesterification catalyst is selected from the group consisting of Group Ia and Group IIa metals.

4. A method as in claim 1, wherein the transesterification catalyst is selected from the group consisting of lithium, sodium, potassium, magnesium, calcium, strontium and barium.

5. A method as in claim 1, wherein the transesterification catalyst is selected from the group consisting of lanthanides metals.

6. A method as in claim 1, wherein the transesterification catalyst is selected from the group consisting of lanthanum and samarium.

7. A method as in claim 1, wherein the transesterification catalyst is titanium.

8. A method as in claim 1, wherein the transesterification catalyst also catalyzes conversion of the vinyl ester end groups to methyl dioxolane and the step of providing egress also provides egress to the formed dioxolane.

9. A method as in claim 1, further comprising the step of forming the polyester into a solid article after the steps of incorporating the vinyl ester transesterification catalyst, heating the polyester, and providing egress.

10. A method as in claim 1, further comprising forming the polyester into a first solid article after incorporating the vinyl ester transesterification catalyst and heating the polyester, and thereafter reheating the polyester, conducting the step of providing egress, and forming the polyester into a second article.

11. A method as in claim 1, wherein the step of heating the polyester comprises melting the polyester.

12. A method as in claim 1, wherein the polyester is melted during heating and formed into a solid article and the solid article is thereafter heated to a temperature sufficient to cause diffusion of acetaldehyde through the solid article.

13. A method as in claim 1, wherein the vinyl ester transesterification catalyst is present in the polyester in the amount of about 5 to about 1000 ppm.

14. A method as in claim 1, wherein the vinyl ester transesterification catalyst is present in the polyester in the amount of about 25 to about 250 ppm.

15. A composition comprising:
a polyester having vinyl ester end groups; and
at least one vinyl ester transesterification catalyst for catalyzing conversion of the vinyl ester end groups to acetaldehyde.

16. A composition as in claim 15, wherein the polyester is based on polyethylene terephthalate.

17. A composition as in claim 15, wherein the transesterification catalyst is selected from the group consisting of Group Ia and Group IIa metals.

18. A composition as in claim 15, wherein the transesterification catalyst is selected from the group consisting of lithium, sodium, potassium, magnesium, calcium, strontium and barium.

19. A composition as in claim 15, wherein the transesterification catalyst is selected from the group consisting of lanthanides metals.

20. A composition as in claim 15, wherein the transesterification catalyst is selected from the group consisting of lanthanum and samarium.

21. A method as in claim 15, wherein the transesterification catalyst is titanium.

22. A composition as in claim 15, wherein the vinyl ester transesterification catalyst is present in the polyester in the amount of about 5 to about 1000 ppm.

23. A composition as in claim 15, wherein the vinyl ester transesterification catalyst is present in the polyester in the amount of about 25 to about 250 ppm.

24. A method for making a polyester article comprising:
incorporating into polyester having vinyl ester end groups at least one active vinyl ester transesterification catalyst for catalyzing conversion of the vinyl ester end groups to acetaldehyde, heating the polyester, and providing egress for the acetaldehyde from the polyester; and
forming the polyester into an article.

25. A method as in claim 24, wherein the polyester is based on polyethylene terephthalate.

26. A method as in claim 24, wherein the transesterification catalyst is selected from the group consisting of Group Ia and Group IIa metals.

27. A method as in claim 24, wherein the transesterification catalyst is selected from the group consisting of lithium, sodium, potassium, magnesium, calcium, strontium and barium.

28. A method as in claim 24, wherein the transesterification catalyst is selected from lanthanides metals

29. A method as in claim 24, wherein the transesterification catalyst is selected from the group consisting of lanthanum and samarium.

30. A method as in claim 24, wherein the transesterification catalyst is titanium.

31. A method as in claim 24, wherein the transesterification catalyst also catalyzes conversion of the vinyl ester end groups to methyl dioxolane and the step of providing egress also provides egress to the formed dioxolane.

32. A method as in claim 24, further comprising the step of forming the polyester into the solid article after the steps of incorporating the vinyl ester transesterification catalyst, heating the polyester, and providing egress.

33. A method as in claim 24, wherein the solid article is a first solid article and the method further comprises forming the polyester into the first solid article after incorporating the vinyl ester transesterification catalyst and heating the polyester, and thereafter reheating the polyester, conducting the step of providing egress, and forming the polyester into a second article.

34. A method as in claim 24, wherein the step of heating the polyester comprises melting the polyester.

35. A method as in claim 24, wherein the polyester is melted during heating and formed into a solid article and the solid article is thereafter heated to a temperature sufficient to cause diffusion of acetaldehyde through the solid article.

36. A method as in claim 24, wherein the vinyl ester transesterification catalyst is present in the polyester in the amount of about 5 to about 1000 ppm.

37. A method as in claim 24, wherein the vinyl ester transesterification catalyst is present in the polyester in the amount of about 25 to about 250 ppm.

38. A method of producing a polyester article that comprises the steps of:
preparing a polyester melt having vinyl ester end groups;
adding a vinyl ester transesterification catalyst for catalyzing conversion of the vinyl ester end groups to acetaldehyde and methyl dioxolane;
venting the formed acetaldehyde and methyl dioxolane from the polyester melt and thereafter
forming the polyester article.

39. A method as in claim 38, wherein the polyester melt is not solidified prior to forming the polyester article.

40. A method as in claim 39, wherein the vinyl ester transesterification catalyst is titanium.
